(19) United States
(12) Patent Application Publication
(10) Pub. No.: US 2015/0315458 A1
(43) Pub. Date: Nov. 5, 2015

(54) A Proppant

(71) Applicant: BASF SE, Ludwigshafen (DE)

(72) Inventors: Christohper M. TANGUAY, Trenton, MI (US); Charles Omotayo KEROBO, Bloomfield Hills, MI (US); Yeonsuk ROH, Canton, MI (US); Stephen F. GROSS, Rockwood, MI (US)

(21) Appl. No.: 14/651,808

(22) PCT Filed: Dec. 9, 2013
(86) PCT No.: PCT/US2013/073892

§ 371 Date: Jun. 12, 2015

Related U.S. Application Data
(60) Provisional application No. 61/737,550, filed on Dec. 14, 2012.

(51) Int. Cl. C09K 8/80; E21B 43/267

(52) U.S. Cl. CPC C09K 8/805; E21B 43/267

(57) ABSTRACT

A proppant includes a surface treatment comprising an antistatic component and a hydrophilic component. The antistatic component comprises a quaternary ammonium compound. The hydrophilic component comprises a polyether polyol. A method of forming the proppant comprises the step of applying the surface treatment onto the proppant.

### FIELD OF THE DISCLOSURE

The subject disclosure generally relates to a proppant and a method of forming the proppant. More specifically, the subject disclosure relates to a proppant which is used during hydraulic fracturing of a subterranean formation.

### BACKGROUND

Domestic energy needs in the United States currently outpace readily accessible energy resources, which has forced an increasing dependence on foreign petroleum fuels, such as oil and gas. At the same time, existing United States energy resources are significantly underutilized, in part due to inefficient oil and gas procurement methods and a deterioration in the quality of raw materials such as unrefined petroleum fuels.

Petroleum fuels are typically procured from subsurface reservoirs via a wellbore. Petroleum fuels are typically procured from low-permeability reservoirs through hydraulic fracturing of subterranean formations, such as bodies of rock having varying degrees of porosity and permeability. Hydraulic fracturing enhances production by creating fractures that emanate from the subsurface reservoir or wellbore, and provides increased flow channels for petroleum fuels. During hydraulic fracturing, specially-engineered carrier fluids are pumped at high pressure and velocity into the subsurface reservoir to cause fractures in the subterranean formations. A propping agent, i.e., a proppant, is mixed with the carrier fluids to keep the fractures open when hydraulic fracturing is complete. The proppant typically comprises a particle and a coating disposed on the particle. The proppant remains in place in the fractures once the high pressure is removed, and thereby props open the fractures to enhance petroleum fuel flow into the wellbore. Consequently, the proppant increases procurement of petroleum fuel by creating a high-permeability, supported channel through which the petroleum fuel can flow.

However, the surface properties of some proppants especially those comprising polymers, e.g. polymer coated sands, are undesirable due to the propensity of the polymer to be hydrophobic and/or a good electrical insulator. These attributes are most accentuated when the polymer is derived from an aromatic polymer. The polymer does not wet out well in water which can hinder the rate at which the proppant comprising the polymer can be dispersed in an aqueous solution. Therefore, the polymer may slow and/or create problems when transferring the proppant comprising the polymer, via pumping, into the wellbore.

Dry proppant is added to a slurry tank and pumped into a wellbore at a rate of approximately 600 lbs/minute. If the proppant does not wet out well with water, the proppant plugs the pumping system and stops production. Polymers that are good insulators also tend to generate static charge and the retention thereof. These static charges also slow and/or create a problems when transferring the proppant, via pumping, into the wellbore. That is, if the proppant generates and retains static charge, the proppant does not sieve well, sticks to surfaces, and stops production. Further, the generation of static charge can damage equipment.

Current practice is to treat the polymer coated sand with a post-treatment with an ionic/amphoteric (having both positive and negative charges) surfactant. However, such ionic surfactants provide nominal static charge dissipation and water wetting ability. Further, the proppant manufacturing process typically involves various processing steps which are conducted at temperatures exceeding 300° F. and these surfactants are temperature sensitive. As such, the proppant must be cooled before application of the prior art surfactants or else these surfactants will decompose, rendering them less effective or even ineffective as an antistat and hydrophile. Further, attempts have been made to apply an aqueous solution comprising a surfactant to the proppant at elevated temperatures but such attempts generally result in flashing which generates voluminous amounts of steam and results in the vaporization of the surfactant.

As such there remains an opportunity to provide a surface treatment for a proppant which is an effective antistat and hydrophile and can be applied and function at standard and elevated temperatures.

### SUMMARY

The subject disclosure provides a proppant which includes a surface treatment comprising an antistatic component and a hydrophilic component. The antistatic component comprises a quaternary ammonium compound. The hydrophilic component comprises a polyether polyol. The subject disclosure also provides a method of forming the proppant comprising the step of applying the surface treatment onto the proppant.

Advantageously, surface treatment has excellent antistatic and hydrophilic properties as a result of the antistatic component and the hydrophilic component. The antistatic component and the hydrophilic component can be efficiently applied to the surface of the proppant, e.g. immediately after the formation of the proppant while the proppant is at an elevated temperature (a temperature greater than 25° C.). Further, the quaternary ammonium compound and the polyether polyol interact with each other and the surface of the proppant to form a surface treatment which provides antistatic and wetting properties throughout the lifecycle of the proppant.

### DETAILED DESCRIPTION

The subject disclosure includes a proppant, a method of forming, or preparing, the proppant, a method of hydraulically fracturing a subterranean formation, and a method of filtering a fluid. The proppant is typically used, in conjunction with a carrier fluid, to hydraulically fracture the subterranean formation which defines a subsurface reservoir (e.g. a wellbore or reservoir itself). Here, the proppant props open the fractures in the subterranean formation after the hydraulic fracturing. In one embodiment, the proppant may also be used to filter unrefined petroleum fuels, e.g. crude oil, in fractures to improve feedstock quality for refineries. However, it is to be appreciated that the proppant of the subject disclosure can also have applications beyond hydraulic fracturing and crude oil filtration, including, but not limited to, water filtration and artificial turf.

The proppant includes a surface treatment which provides effective antistatic and wetting properties throughout the lifecycle of the proppant. The surface treatment comprises an antistatic component and a hydrophilic component. The antistatic component comprises a quaternary ammonium compound. The hydrophilic component comprises a polyether polyol. The antistatic component is typically disposed on an outer surface of the proppant.

As used herein, the terminology “disposed on” encompasses the surface treatment being disposed about the outer surface and also encompasses both partial and complete covering of the outer surface of the proppant. The surface treatment is disposed on the outer surface to an extent sufficient to change the properties of the outer surface, e.g. to form a proppant which is both resistant to the build up of static electricity and hydrophilic and can thus be efficiently used. As such, any given sample of the proppant typically includes particles having the surface treatment disposed thereon, and the surface treatment is typically disposed on a large enough surface area of each particle so that the sample of the proppant can be used to prop open fractures in the subterranean formation during and after the hydraulic fracturing, filter crude oil, etc. The surface treatment is described additionally further below.

The proppant typically comprises a particle. Although the particle may be any size, the particle typically has a particle size distribution of from 10 to 100 mesh, more typically 20 to 70 mesh, as measured in accordance with standard sizing techniques using the United States Sieve Series. That is, the particle typically has a particle size of from 149 to 2,000, more typically of from 210 to 841, μm.

Although the shape of the particle is not critical, particles having a spherical shape typically impart a smaller increase in viscosity to a hydraulic fracturing composition than particles having other shapes, as set forth in more detail below. The hydraulic fracturing composition is a mixture comprising the carrier fluid and the proppant. Typically, the particle is either round or roughly spherical.

The particle typically contains less than 1 part by weight of moisture, based on 100 parts by weight of the particle. Particles containing greater than 1 part by weight of moisture typically interfere with sizing techniques and prevent uniform coating of the particle.

Suitable particles for purposes of the subject disclosure include any known particle for use during hydraulic fracturing, water filtration, or artificial turf preparation. Non-limiting examples of suitable particles include minerals, ceramics such as sintered ceramic particles, sands, nut shells, gravels, mine tailings, coal ashes, rocks (such as bauxite), smelter slag, diatomaceous earth, crushed charcoals, micas, sawdust, wood chips, resinous particles, polymeric particles, and combinations thereof. It is to be appreciated that other particles not recited herein may also be suitable for the purposes of the subject disclosure.

Sand is a preferred particle and when applied in this technology is commonly referred to as frac, or fracturing, sand. Examples of suitable sands include, but are not limited to, Arizona sand, Badger sand, Brady sand, Northern White sand, and Ottawa sand. Based on cost and availability, inorganic materials such as sand and sintered ceramic particles are typically favored for applications not requiring filtration.

A specific example of a sand that is suitable as a particle for the purposes of the subject disclosure is Arizona sand, a natural grain that is derived from weathering and erosion of preexisting rocks. As such, this sand is typically coarse and is roughly spherical. Another specific example of a sand that is suitable as a particle for the purposes of this disclosure is Ottawa sand, commercially available from U.S. Silica Company of Berkeley Springs, W. Va. Yet another specific example of a sand that is suitable as a particle for the purposes of this disclosure is Wisconsin sand, commercially available from Badger Mining Corporation of Berlin, Wis. Particularly preferred sands for application in this disclosure are Ottawa and Wisconsin sands. Ottawa and Wisconsin sands of various sizes, such as 30/50, 20/40, 40/70, and 70/140 can be used.

Specific examples of suitable sintered ceramic particles include, but are not limited to, aluminum oxide, silica, bauxite, and combinations thereof. The sintered ceramic particle may also include clay-like binders.

An active agent may also be included in the particle. In this context, suitable active agents include, but are not limited to, organic compounds, microorganisms, and catalysts. Specific examples of microorganisms include, but are not limited to, anaerobic microorganisms, aerobic microorganisms, and combinations thereof. A suitable microorganism for the purposes of the subject disclosure is commercially available from—LUCA Technologies of Golden, Colo. Specific examples of suitable catalysts include fluid catalytic cracking catalysts, hydroprocessing catalysts, and combinations thereof. Fluid catalytic cracking catalysts are typically selected for applications requiring petroleum gas and/or gasoline production from crude oil. Hydroprocessing catalysts are typically selected for applications requiring gasoline and/or kerosene production from crude oil. It is also to be appreciated that other catalysts, organic or inorganic, not recited herein may also be suitable for the purposes of the subject disclosure.

Such additional active agents are typically favored for applications requiring filtration. As one example, sands and sintered ceramic particles are typically useful as a particle for support and propping open fractures in the subterranean formation which defines the subsurface reservoir, and, as an active agent, microorganisms and catalysts are typically useful for removing impurities from crude oil or water. Therefore, a combination of sands/sintered ceramic particles and microorganisms/catalysts as active agents are particularly preferred for crude oil or water filtration.

Suitable particles for purposes of the present disclosure may be formed from resins and polymers. Specific non-limiting examples of polymers which the particle may be comprised of include polyurethane, polycarbodiimide, polyamide, polyimide, polyurea, polyacrylate, epoxy, polystyrene, polysulfide, polyoxazolidone, polyisocyanaurate, polysilicate (sodium silicates), polyvinylchloride, phenol formaldehyde resins (novolacs and resoles), and combinations thereof.

The proppant typically comprises a polymeric coating disposed on the particle. In this embodiment, the surface treatment is disposed on the polymeric coating. The polymeric coating typically provides the particle with protection from operating temperatures and pressures in the subterranean formation and/or subsurface reservoir. Further, the polymeric coating typically protects the particle against closure stresses exerted by the subterranean formation. The polymeric coating also typically protects the particle from ambient conditions and minimizes disintegration and/or dusting of the particle. In some embodiments, the polymeric coating may also provide the proppant with desired chemical reactivity and/or filtration capability.

The polymeric coating typically comprises a polymer selected from the group of polyurethane, polycarbodiimide, polyamide, polyimide, polyurea, polyacrylate, epoxy, polystyrene, polysulfide, polyoxazolidone, polyisocyanaurate, polysilicate (sodium silicate), polyvinylchloride, phenol formaldehyde resins (novolacs and resoles), and combinations thereof. It is to be appreciated that other polymeric coatings not recited herein may also be suitable for the purposes of the subject disclosure. The polymeric coating is typically selected based the polymeric coating's physical properties and operating conditions at which the proppant is to be used.

In a one embodiment the polymeric coating comprises polycarbodiimide, i.e., is a polycarbodiimide coating. The polycarbodiimide coating is typically selected for applications that require excellent adhesion to the particle physical stability. As one example, the polycarbodiimide coating is particularly applicable when the proppant is exposed to significant compression and/or shear forces, and temperatures exceeding 200° F., alternatively 500° F. in the subterranean formation and/or subsurface reservoir defined by the formation. The polycarbodiimide coating is generally viscous to solid nature, and depending on molecular weight, is typically sparingly soluble or insoluble in organic solvents. Any suitable polycarbodiimide coating may be used for the purposes of the subject disclosure.

Typically, the polycarbodiimide coating is formed by reacting an isocyanate in the presence of a catalyst. The polycarbodiimide coating can be the reaction product of one type of isocyanate. However, for this disclosure, the polycarbodiimide coating is preferably the reaction product of at least two different types of isocyanates such that the isocyanate introduced above is defined as a first isocyanate and a second isocyanate that is different from the first isocyanate. Obviously, the polycarbodiimide coating may be the reaction product of more than two isocyanates.

The isocyanate may be any type of isocyanate known to those skilled in the art. The isocyanate may be a polyisocyanate having two or more functional groups, e.g. two or more NCO functional groups. Suitable isocyanates for purposes of the present disclosure include, but are not limited to, aliphatic and aromatic isocyanates. In various embodiments, the isocyanate is selected from the group of diphenylmethane diisocyanates (MDIs), polymeric diphenylmethane diisocyanates (pMDIs), toluene diisocyanates (TDIs), hexamethylene diisocyanates (HDIs), isophorone diisocyanates (IPDIs), and combinations thereof.

The isocyanate may be an isocyanate prepolymer. The isocyanate prepolymer is typically a reaction product of an isocyanate and a polyol and/or a polyamine. The isocyanate used in the prepolymer can be any isocyanate as described above. The polyol used to form the prepolymer is typically selected from the group of ethylene glycol, diethylene glycol, propylene glycol, dipropylene glycol, butane diol, glycerol, trimethylolpropane, triethanolamine, pentaerythritol, sorbitol, biopolyols, and combinations thereof. The polyamine used to form the prepolymer is typically selected from the group of ethylene diamine, toluene diamine, diaminodiphenylmethane and polymethylene polyphenylene polyamines, aminoalcohols, and combinations thereof. Examples of suitable amino alcohols include ethanolamine, diethanolamine, triethanolamine, and combinations thereof.

Specific isocyanates that may be used to prepare the polycarbodiimide coating include, but are not limited to, toluene diisocyanate; 4,4′-diphenylmethane diisocyanate; m-phenylene diisocyanate; 1,5-naphthalene diisocyanate; 4-chloro-1; 3-phenylene diisocyanate; tetramethylene diisocyanate; hexamethylene diisocyanate; 1,4-dicyclohexyl diisocyanate; 1,4-cyclohexyl diisocyanate, 2,4,6-toluylene triisocyanate, 1,3-diisopropylphenylene-2,4-dissocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl benzene-2,4,6-triisocyanate and 1,3,5-triisopropyl benzene-2,4,6-triisocyanate. Other suitable polycarbodiimide coatings can also be prepared from aromatic diisocyanates or isocyanates having one or two aryl, alkyl, or alkoxy substituents wherein at least one of these substituents has at least two carbon atoms. As indicated above, multiple isocyanates may be reacted to form the polycarbodiimide coating. When one or more isocyanates are reacted to form the polycarbodiimide coating, the physical properties of the polycarbodiimide coating, such as hardness, strength, toughness, creep, and brittleness can be further optimized and balanced.

In one embodiment, a mixture of monomeric and polymeric isocyanates is reacted to form the polycarbodiimide coating. In another embodiment, polymeric isocyanate and monomeric isocyanate react in a weight ratio of 10:1 to 1:10, alternatively 4:1 to 1:4, alternatively 2.5:1 to 1:1, alternatively 2.0:1, to form the polycarbodiimide coating. For example, LUPRANATE® M20 can be reacted to form the polycarbodiimide coating.

In one embodiment, the first isocyanate is reacted with the second isocyanate to form the polycarbodiimide coating. In this embodiment, the first isocyanate is further defined as a polymeric isocyanate, and the second isocyanate is further defined as a monomeric isocyanate. The polymeric isocyanate (e.g. LUPRANATE® M20) is typically reacted in an amount of from 20 to 100, alternatively from 40 to 80, alternatively from 60 to 70, parts by weight and the monomeric isocyanate (e.g. LUPRANATE® M) is typically reacted in an amount of from 20 to 80, alternatively from 25 to 60, alternatively from 30 to 40, parts by weight, both based on a total combined weight of the polymeric and monomeric isocyanates.

The one or more isocyanates are typically heated in the presence of the catalyst to form the polycarbodiimide coating. Generally, the catalyst is selected from the group of phosphorous compounds, tertiary amides, basic metal compounds, carboxylic acid metal salts, non-basic organo-metallic compounds, and combinations thereof. For example, the one or more isocyanates may be heated in the presence of a phosphorous compound to form the polycarbodiimide coating. Suitable examples of the phosphorous compound include, but are not limited to, phospholene oxide catalysts such as 3-methyl-1-phenyl-2-phospholene oxide (MPPO), 3-methyl-1-ethyl-2-phospholene oxide (MEPO), 3,4-dimethyl-1-phenyl-3-phospholene oxide, 3,4-dimethyl-1-ethyl-3-phospholene oxide, 1-phenyl-2-phospholen-1-oxide, 3-methyl-1-2-phospholen-1-oxide, 1-ethyl-2-phospholen-1-oxide, 3-methyl-1-phenyl-2-phospholen-1-oxide, and 3-phospholene isomers thereof.

In one suitable, non-limiting example, the phospholene oxide catalyst has the following structure:

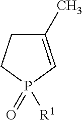

wherein R¹ is a hydrocarbon group.

R¹ can be an aryl group. In one embodiment, the aryl group is a phenyl group. i.e., the phospholene oxide catalyst is MPPO. MPPO is a particularly suitable phospholene oxide catalyst and has the following structure:

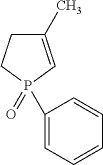

R¹ can be an alkyl group. In one embodiment, the alkyl group is an ethyl group. i.e., the phospholene oxide catalyst is MEPO. MEPO is also a particularly suitable phospholene oxide catalyst and has the following structure:

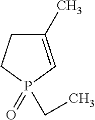

In another suitable, non-limiting example, the phospholene oxide catalyst has the following structure:

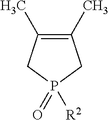

wherein R² is a hydrocarbon group.

R² can be an aryl group. In one embodiment, the aryl group is a phenyl group. i.e., the phospholene oxide catalyst is 3,4-dimethyl-1-phenyl-3-phospholene oxide. 3,4-dimethyl-1-phenyl-3-phospholene oxide is a suitable phospholene oxide catalyst and has the following structure:

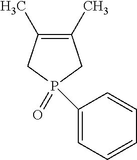

R2 can be an alkyl group. In one embodiment, the alkyl group is an ethyl group. i.e., the phospholene oxide catalyst is 3,4-dimethyl-1-ethyl-3-phospholene oxide. 3,4-dimethyl-1-ethyl-3-phospholene oxide is a suitable phospholene oxide catalyst and has the following structure:

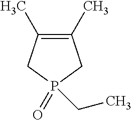

Additional suitable examples of the phosphorous compound include, but are not limited to, phospholene sulfide catalysts such as 3-methyl-1-phenyl-2-phospholene sulfide (MPPS) and 3-methyl-1-ethyl-2-phospholene sulfide (MEPS).

In one suitable, non-limiting example, the phospholene sulfide catalyst has the following structure:

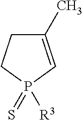

wherein R³ is a hydrocarbon group.

R³ can be an aryl group. In one embodiment, the aryl group is a phenyl group. i.e., the phospholene sulfide catalyst is MPPS. MPPS is a particularly suitable phospholene sulfide catalyst and has the following structure:

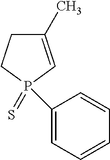

R³ can be an alkyl group. In one embodiment, the alkyl group is an ethyl group. i.e., the phospholene sulfide catalyst is MEPS. MEPS is also a particularly suitable phospholene sulfide catalyst and has the following structure:

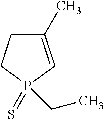

Additional suitable examples of the phosphorous compound include, but are not limited to, phosphetane oxide catalysts such as 2,2,3-trimethyl-1-phenylphosphetane 1-oxide and 2,2,3,3-tetramethyl-1-phenylphosphetane 1-oxide.

In one suitable, non-limiting example, the phosphetane oxide catalyst has the following structure:

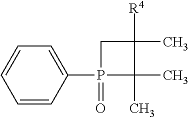

wherein R⁴ is a hydrogen atom or a hydrocarbon group.

In one embodiment, R⁴ is a hydrogen atom. i.e., the phosphetane oxide catalyst is 2,2,3-trimethyl-1-phenylphosphetane 1-oxide, which has the following structure:

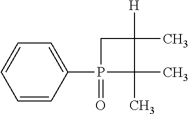

In another embodiment, R⁴ is a methyl group. i.e., the phosphetane oxide catalyst is 2,2,3,3-tetramethyl-l-phenylphosphetane 1-oxide, which has the following structure:

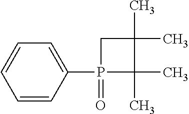

The catalyst is typically present in the polycarbodiimide coating in an amount of from 1 to 10,000, alternatively from 2 to 750, alternatively from 3 to 500, PPM.

Specific polycarbodiimide coatings which are suitable for the purposes of the subject disclosure include, but are not limited to, monomers, oligomers, and polymers of diisopropylcarbodiimide, dicyclohexylcabodiimide, methyl-tert-butylcarbodiimide, 2,6-diethylphenyl carbodiimide; di-ortho-tolyl-carbodimide; 2,2′-dimethyl diphenyl carbodiimide; 2,2′-diisopropyl-diphenyl carbodiimide; 2-dodecyl-2′-n-propyl-diphenylcarbodiimide; 2,2′-diethoxy-diphenyl dichloro-diphenylcarbodiimide; 2,2′-ditolyl-diphenyl carbodiimide; 2,2′-dibenzyl-diphenyl carbodiimide; 2,2′-dinitro-diphenyl carbodiimide; 2-ethyl-2′-isopropyl-diphenyl carbodiimide; 2,6,2′,6′-tetraethyl-diphenyl carbodiimide; 2,6,2′,6′-tetrasecondary-butyl-diphenyl carbodiimide; 2,6,2′,6′-tetraethyl-3,3′-dichloro-diphenyl carbodiimide; 2-ethyl-cyclohexyl-2-isopropylphenyl carbodiimide; 2,4,6,2′,4′,6′-hexaisopropyl-diphenyl carbodiimide; 2,2′-diethyl-dicyclohexyl carbodiimide; 2,6,2′,6′-tetraisopropyl-dicyclohexyl carbodiimide; 2,6,2′,6′tetraethyl-dicyclohexy) carbodiimide and 2,2′-dichlorodicyclohexyl carbodiimide; 2,2′-dicarbethoxy diphenyl carbodiimide; 2,2′-dicyano-diphenyl carbodiimide and the like.

If present, the polymeric coating is typically present in the proppant in an amount of from 0.1 to 15, alternatively from 0.1 to 10, alternatively from 0.5 to 7.5, alternatively from 1.0 to 6.0, alternatively from 1 to 3.5, parts by weight based on 100 parts by weight of the particle.

The polycarbodiimide coating may be formed in-situ where the polycarbodiimide coating is disposed on the particle during formation of the polycarbodiimide coating. Said differently, the components of the polycarbodiimide coating are typically combined with the particle and the polycarbodiimide coating is disposed on the particle. However, in one embodiment a polycarbodiimide coating is formed and some time later applied to, e.g. mixed with, the particle and exposed to temperatures exceeding 100° C. to coat the particle and form the proppant.

As indicated above, the polycarbodiimide coating is typically formed by reacting an isocyanate, or isocyanates, in the presence of a catalyst. However, it is to be understood that the polycarbodiimide coating can be formed from other reactants which are not isocyanates. As just one example, the polycarbodiimide coating of this disclosure can be formed with ureas, e.g. thioureas, as reactants. Other examples of reactants suitable for formation of polycarbodiimide are described in “Chemistry and Technology of Carbodiimides”, Henri Ulrich, John Wiley &Sons, Ltd., Chichester, West Sussex, England (2007), the disclosure of which is hereby incorporated by reference in its entirety.

The surface treatment comprises the antistatic component. The antistatic component comprises one or more antistatic compounds or antistats. The antistat reduces, removes, and prevents the buildup of static electricity on the proppant. The antistat can be a non-ionic antistat or an ionic or amphoteric antistat (which can be further classified as anionic or cationic). Ionic antistats are compounds that include at least one ion, i.e., an atom or molecule in which the total number of electrons is not equal to the total number of protons, giving it a net positive or negative electrical charge. As described further below, the quaternary ammonium compound of the subject disclosure is typically an ionic antistat which has a quaternary ammonium cation, often referred to as a quat. Non-ionic antistats are organic compounds composed of both a hydrophilic and a hydrophobic portion. Of course, the antistatic component can comprise a combination of ionic and non-ionic antistats.

Ionic antistats are effective for proppants which have a polar surface, e.g. a polymeric surface such as polycarbodiimide or polyvinyl chloride surface. For example, a proppant comprising a particle formed from polycarbodiimide or a proppant comprising a particle such as frac sand coated with polycarbodiimide can be treated with an ionic antistat to effectively reduce, remove, and prevent the buildup of static electricity on the proppant. However, ionic antistats tend to have inherently low heat stability and the manufacturing of proppants typically requires temperatures in excess of 100° C. The antistatic component (antistats) of this disclosure are typically stable at temperatures greater than 100° C. As such, the proppant does not have to be cooled prior to application of the surface treatment because the antistat will not decompose at elevated temperatures. Thus the antistat typically retains its anti-static and hydrophilic properties, even if applied onto the proppant at elevated temperatures. This provides many advantages because the proppant can be formed and the surface treatment applied quickly thereafter in a single step.

The antistatic component of the subject disclosure comprises the quaternary ammonium compound. The quaternary ammonium compound includes a quaternary ammonium cation, often referred to as a quat. Quats are positively charged polyatomic ions of the structure NR₄+, R being an alkyl group or an aryl group. Unlike the ammonium ion (NH₄+) and the primary, secondary, or tertiary ammonium cations, quats are permanently charged, independent of the pH of their solution.

As described above, the quats are positively charged polyatomic ions of the structure NR₄+, R being an alkyl group or an aryl group. In one embodiment, at least one of R¹ through R⁴ is a C12 through C20 alkyl group. In another embodiment, at least two of R¹ through R⁴ is a C12 through C20 alkyl group. In yet another embodiment, at least two of R¹ through R⁴ is a C12 through C20 alkyl group which includes a carbonyl group.

The quaternary ammonium compound can be a quaternary ammonium salt comprising a quat and an anion. In one embodiment, the quaternary ammonium compound comprises a chloride anion. In another embodiment, the quaternary ammonium compound comprises a metho sulfate anion.

The quaternary ammonium compound typically has a weight-average molecular weight of greater than 150, alternatively greater than 300, alternatively greater than 500, alternatively of from 150 to 5,000, alternatively from 300 to 4,000 g/mol, alternatively from 500 to 3,000 g/mol, alternatively from 500 to 1,500, alternatively from 500 to 600, g/mol. Cationic quaternary ammonium compounds having a molecular weight of greater than 500 g/mol are particularly effective in the antistatic component.

The quaternary ammonium compound typically has a decomposition rate of no more than 60, alternatively no more than 40, alternatively no more than 20, weight percent per hour at 70° C. Further, the quaternary ammonium compound is typically thermally stable at 100, alternatively 150, alternatively 170, alternatively 190, ° C., for time periods of from up to 2, alternatively up to 3, alternatively up to 4, alternatively up to 5, alternatively up to 6, alternatively up to 7, alternatively up to 8, alternatively up to 10, alternatively up to 12, alternatively up to 14, alternatively up to 16, alternatively up to 18, alternatively up to 20, alternatively up to 30, minutes. Furthermore, the quaternary ammonium compound typically has weight loss of less than 25, alternatively less than 15, alternatively less than 10, alternatively less than 8, alternatively less than 6, alternatively less than 5, alternatively less than 4, alternatively less than 3, alternatively less than 2, alternatively less than 1, alternatively 0, weight percent after exposure to a temperature of 100, alternatively 150, alternatively 170, alternatively 190, ° C., for a time period of up to 2, alternatively up to 3, alternatively up to 4, alternatively up to 5, alternatively up to 6, alternatively up to 7, alternatively up to 8, alternatively up to 10, alternatively up to 12, alternatively up to 14, alternatively up to 16, alternatively up to 18, alternatively up to 20, alternatively up to 30, minutes.

In one embodiment, the quaternary ammonium compound has a weight loss of 0 percent by weight after four minutes at 190° C. In another embodiment, the quaternary ammonium compound has a weight loss of less than 2 percent by weight after four minutes at 190° C. In yet another embodiment, the quaternary ammonium compound has a weight loss of less than 5 percent by weight after four minutes at 190° C.

In one embodiment, the quaternary ammonium compound is dicocoyl ethyl hydroxyethylmonium methosulfate. Dicocoyl ethyl hydroxyethylmonium methosulfate is the reaction product of triethanol amine, fatty acids, and methosulfate.

Notably, dicocoyl ethyl hydroxyethylmonium methosulfate is a cationic antistat having a cationic-active matter content of 74 to 79% when tested in accordance with International Organization for Standardization (“ISO”) 2871-1:2010. ISO 2871 specifies a method for the determination of the cationic-active matter content of high-molecular-mass cationic-active materials such as quaternary ammonium compounds in which two of the alkyl groups each contain 10 or more carbon atoms, e.g. distearyl-dimethyl-ammonium chlorides, or salts of imidazoline or 3-methylimidazoline in which long-chain acylaminoethyl and alkyl groups are substituted in the 1- and 2-positions, respectively.

Dicocoyl ethyl hydroxyethylmonium methosulfate has an acid value of not greater than 12 when tested in accordance with ISO 4314-1977 (Surface active agents—Determination of free alkalinity or free acidity—Titrimetric method) and a pH of from 2.5 to 3 when tested in accordance with ISO 4316:1977 (Determination of pH of aqueous solutions—Potentiometric method).

In addition to the quaternary ammonium compound, e.g. dicocoyl ethyl hydroxyethylmonium methosulfate, the antistatic component may further comprise a solvent, such as propylene glycol. In one such embodiment, the antistatic component comprises mixture of dicocoyl ethyl hydroxyethylmonium methosulfate and propylene glycol.

The quaternary ammonium compound is typically present in the surface treatment in an amount of from 5 to 95, more typically from 10 to 60, and most typically from 20 to 50, parts by weight based on 100 parts by weight of the quaternary ammonium compound and the polyether polyol present in the surface treatment. The amount of the quaternary ammonium compound present in the surface treatment may vary outside of the ranges above, but is typically both whole and fractional values within these ranges.

The surface treatment also comprises the hydrophilic component which comprises the polyether polyol. The polyether polyol has a weight average molecular weight of greater than 150, alternatively greater than 298, alternatively greater than 3000, alternatively from 250 to 10,000, alternatively from 500 to 5,000, alternatively from 500 to 3,000, alternatively from 2,000 to 4,000, alternatively from 2,500 to 4,500, g/mol. The polyether polyol has a nominal functionality of from 1 to 8, alternatively from 1 to 5, alternatively from 1 to 4, alternatively about 1, alternatively about 3.

The polyether polyol is generally produced by reacting an initiator with an alkylene oxide in the presence of a catalyst, such as a basic catalyst or a double metal cyanide (DMC) catalyst. The initiator a low-functionality, i.e., f<4, initiator, e.g. gyycerine (f=3), trimethynol propane (f=3), octlydimethylamine (F=1), or methanol (F=1). The low-functionality initiator undergoes an oxyalkylation reaction with the alkylene oxide to form the polyether polyol comprising a core formed from the initiator and a plurality of polymeric side chains formed from the alkylene oxide. The plurality of polymeric side chains comprise alkeyleneoxy groups and alkoxyl end caps.

The alkylene oxide is typically selected from the group of ethylene oxide (EO), propylene oxide (PO), butylene oxide (BO), and combinations thereof. Upon reaction, EO forms ethyleneoxy groups, PO forms propyleneoxy groups, and BO forms butyleneoxy groups within the polymeric side chains. The arrangement of ethyleneoxy, propyleneoxy, and butyleneoxy groups in the polymeric side chains of the polyether polyol is independently selected from the group of random groups, repeating groups, and block groups. The plurality of polymeric side chains of the polyether polyol may be branched or linear, but are typically linear. In one embodiment, polyether polyol comprises ethyleneoxy groups and propyleneoxy groups in a molar ratio of from 4:1 to 1:15, alternatively from 1:3 to 1:11, alternatively about 1:11, alternatively about 1:3.

Each polymeric side chain has an end cap which is formed from the alkylene oxide and comprises an alkoxyl group. EO forms EO end caps, PO forms PO end caps, and BO forms BO end caps. In certain embodiments, EO is utilized such that the resulting polyether polyol is EO end capped. EO end caps have a secondary hydroxyl group. In other embodiments, PO is utilized such that the resulting polyether polyol is PO end capped. PO end caps have a primary hydroxyl group. Primary hydroxyl groups are more reactive than secondary hydroxyl groups, i.e., primary hydroxyl groups typically react faster than secondary hydroxyl groups. Of course, a combination of EO, PO, and BO can be utilized in various amounts such that the resulting polyether polyol has a random arrangement of EO end caps, PO end caps, and BO end caps. In one embodiment, the polyether polyol has a plurality of end caps which are substantially free of EO groups. In another embodiment, the polyether polyol has about 100% EO end caps. However, it is to be appreciated that the end caps of the polyether polyol may comprise other alkylene oxide end caps, such as BO end caps, or combinations of EO, PO, and BO end caps. Stated differently, the plurality of end caps of the polyether polyol are typically formed from an alkylene oxide such as EO, PO, BO, and combinations thereof.

In a preferred embodiment, the polyether polyol has greater than 25% PO end caps. In another preferred embodiment, the polyether polyol has about 100% PO end caps. More specifically, by “about” 100% PO end caps, it is meant that all intended capping of the polyether polyol is PO capping, with any non PO end caps resulting from trace amounts of alkylene oxides other than propylene oxide or other impurities. As such, the end capping is typically 100% PO, but may be slightly lower, such as at least 99% ethylene oxide capping, depending on process variables and the presence of impurities during the production of the polyether polyol. The about 100% PO end caps typically provide secondary hydroxyl groups, which are less reactive than primary hydroxyl groups because a PO end capped polyol is stearically hindered. In various embodiments, PO end blocks are incorporated to decrease the content of relatively less reactive secondary hydroxyl groups of the polyether polyol.

For example, in certain embodiments in which the polyether polyol is a gyycerin initiated polyether triol, the polyether polyol has the following general structure:

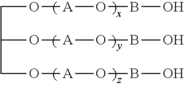

wherein each A is an independently selected bivalent hydrocarbon group having from 2 to 4 carbon atoms; each B is a bivalent hydrocarbon group having 3 carbon atoms; and x, y and z are each integers greater than 1. In this embodiment, the polymeric side chains of the polyether polyol comprise random and/or repeating units formed from EO, PO, and/or BO, and the terminal caps of the polyether polyol comprise units comprise PO groups. The polyether polyol typically has a hydroxyl number of from 20 to 100, more typically from 35 to 75 mg KOH/g.

In one embodiment, a glycerine initiated polyether triol having a molecular weight of greater than 3000 g/mol, a nominal functionality of about 3, and PO end capping is particularly effective in the hydrophilic component. In another embodiment, a glycerine initiated polyether triol having a molecular weight of greater than 3000 g/mol, a nominal functionality of about 3, and 100% PO end caps is particularly effective in the hydrophilic component. The polyether triols of these embodiments are typically thermally stable for short periods of time, e.g. 5 minutes, at temperatures exceeding 170° C. and impart hydrophilic character to the proppant.

However, the polyether polyol of the subject disclosure need not be a polyether triol. For example, polyether polyols having a molecular weight of from 500 to 3000 g/mol, a nominal functionality of 1, and 100% EO end capping are also particularly effective in the hydrophilic component. The polyether polyols of this example are typically thermally stable for short periods of time, e.g. 5 minutes, at temperatures exceeding 170° C. and impart hydrophilic character to the proppant.

The hydrophilic component may further comprise an antioxidant, a solvent, and/or other additives. In a preferred embodiment, the polyether polyol is formulated with a low volatile inhibitor package which includes the antioxidant. In such an embodiment, the low volatile inhibitor improves the stability of the polyether polyol at elevated temperatures, e.g. at temperatures greater than 100° C.

The polyether polyol retains its anti-static and hydrophilic properties, even if applied onto the proppant at elevated temperatures. This provides many advantages because the proppant can be formed and the surface treatment applied quickly thereafter in a single step.

The polyether polyol of this disclosure is typically thermally stable at 100, alternatively 150, alternatively 170, alternatively 190, ° C., for time periods of from up to 2, alternatively up to 3, alternatively up to 4, alternatively up to 5, alternatively up to 6, alternatively up to 7, alternatively up to 8, alternatively up to 10, alternatively up to 12, alternatively up to 14, alternatively up to 16, alternatively up to 18, alternatively up to 20, alternatively up to 30, minutes. Further, the polyether polyol typically has weight loss of less than 25, alternatively less than 15, alternatively less than 10, alternatively less than 8, alternatively less than 6, alternatively less than 5, alternatively less than 4, alternatively less than 3, alternatively less than 2, alternatively less than 1, alternatively 0, weight percent after exposure to a temperature of 100, alternatively 150, alternatively 170, alternatively 190, ° C., for time periods of up to 2, alternatively up to 3, alternatively up to 4, alternatively up to 5, alternatively up to 6, alternatively up to 7, alternatively up to 8, alternatively up to 10, alternatively up to 12, alternatively up to 14, alternatively up to 16, alternatively up to 18, alternatively up to 20, alternatively up to 30, minutes.

In one embodiment, the polyether polyol has a weight loss of less than 1 percent by weight after four minutes at 190° C. In another embodiment, the polyether polyol has a weight loss of less than 2 percent by weight after four minutes at 190° C. In yet another embodiment, the polyether polyol has a weight loss of less than 5 percent by weight after four minutes at 190° C.

The polyether polyol is typically present in the surface treatment in an amount of from 05 to 95, alternatively from 25 to 75, alternatively from 40 to 80, parts by weight based on 100 parts by weight of the quaternary ammonium compound and the polyether polyol present in the surface treatment. The amount of the polyether polyol present in the surface treatment may vary outside of the ranges above, but is typically both whole and fractional values within these ranges.

In one embodiment, the surface treatment includes the quaternary ammonium compound and the polyether polyol in a weight ratio of 4:1 to 1:4, alternatively, 3:1 to 1:3, alternatively 2:3 to 1:2. By adjusting the ratio of the quaternary ammonium compound to the polyether polyol in the surface treatment the surface treatment can be specifically tailored for use with specific proppants, e.g. specific polymeric coatings, and for hydraulically fracturing subterranean formations within specific subsurface reservoirs which have particular temperatures and pressures.

The surface treatment may further include additives. Suitable additives include, but are not limited to, surfactants, blowing agents, wetting agents, blocking agents, dyes, pigments, diluents, solvents, specialized functional additives such as antioxidants, ultraviolet stabilizers, biocides, adhesion promoters, fire retardants, fragrances, and combinations of the group. For example, a pigment allows the surface treatment to be visually evaluated for thickness and integrity and can also provide various marketing advantages.

The surface treatment is typically present on an outer surface of the proppant in an amount of from 0.01 to 10, alternatively from 0.01 to 5, alternatively from 0.01 to 4, alternatively from 0.01 to 1, alternatively from 0.1 to 1, alternatively from 0.1 to 0.4, percent by weight based on the total weight of the proppant, solvents excluded. Said differently, the quaternary ammonium compound and the polyether polyol are typically present on an outer surface of the proppant in an amount of from 0.01 to 10, alternatively from 0.01 to 5, alternatively from 0.01 to 4, alternatively from 0.01 to 1, alternatively from 0.1 to 1, alternatively from 0.1 to 0.4, percent by weight based on the total weight of the proppant. The amount of surface treatment present in the proppant may vary outside of the ranges above, but is typically both whole and fractional values within these ranges.

The surface treatment is typically applied to an outer surface of the proppant. However, the surface treatment may be internal, e.g. mixed with the components used to form the particle or the polymeric coating.

The surface treatment is typically selected for applications requiring excellent coating stability and adhesion to the particle. The surface treatment is chemically and physically stable over a range of temperatures and does not typically melt, degrade, and/or shear off the particle in an uncontrolled manner when exposed to elevated pressures and temperatures, e.g. pressures and temperatures greater than pressures and temperatures typically found on the earth's surface.

The surface treatment typically exhibits excellent hydrolytic resistance and will not lose strength and durability when exposed to water. Consequently, the proppant will maintain its antistatic and hydrophilic properties even upon exposure to water.

The surface treatment typically exhibits excellent adhesion to inorganic and polymeric substrates. That is, the surface treatment wets out and bonds with inorganic surfaces, such as the surface of a sand particle, which consists primarily of silicon dioxide and also wets out and bonds with polymers such a polycarbodiimides and acrylics.

Without being bound by theory, it is believed that the surface treatment interacts with atmospheric moisture forming a microscopic layer of water on the outer surface of the proppant. This layer of water is held in place mainly by hydrogen bonds. The water layer provides the conductive path for static charge dissipation and facilitates the wet out of the proppant.

The surface treatment retains its anti-static and hydrophilic properties, even if applied onto the proppant at elevated temperatures. This provides many advantages because the proppant can be formed and the surface treatment applied quickly thereafter in a single step.

Referring now to the proppant, the proppant typically exhibits excellent thermal stability for high temperature and pressure applications. The proppant is typically stable at temperatures greater than 100, alternatively greater than 150, alternatively greater than 200, alternatively greater than 250, alternatively from 100 to 250, ° C., and/or pressures (independent of the temperatures described above) greater than 7,500 psi, alternatively greater than 10,000, alternatively greater than 12,500, alternatively greater than 15,000, psi. The proppant of this disclosure does not suffer from complete failure of the surface treatment due to shear or degradation when exposed to such temperatures and pressures.

Although customizable according to carrier fluid selection, the proppant typically has a bulk specific gravity of from 0.1 to 3.0, alternatively from 1.0 to 2.0, g/cm³. Further, the proppant of such an embodiment typically has an apparent density, i.e., a mass per unit volume of proppant of from 1.0 to 3.0, alternatively from 1.6 to 3.0, g/cm³ according to American Petroleum Institute (API) RP60 recommended practices for testing high-strength proppants used in hydraulic fracturing operations. One skilled in the art typically selects the specific gravity of the proppant according to the specific gravity of the carrier fluid and whether it is desired that the proppant be lightweight or substantially neutrally buoyant in the selected carrier fluid.

Further, the proppant, due in large part to the surface treatment, typically minimizes unpredictable consolidation. That is, the proppant only consolidates, if at all, in a predictable, desired manner according to carrier fluid selection and operating temperatures and pressures. Also, the proppant is typically compatible with low-viscosity carrier fluids having viscosities of less than 3,000 cps at 80° C. and is typically substantially free from mechanical failure and/or chemical degradation when exposed to the carrier fluids and high pressures. Finally, the proppant is typically coated via economical coating processes and typically does not require multiple coating layers, and therefore minimizes production costs.

As set forth above, the subject disclosure also provides the method of forming, or preparing, the proppant. As with all other components which may be used in the method of the subject disclosure, the particle, the polymeric coating, and the surface treatment (e.g. the quaternary ammonium compound and the polyether polyol) are just as described above with respect to the proppant. The method includes the step of applying the surface treatment comprising the antistatic component comprising the quaternary ammonium compound and hydrophilic component comprising the polyether polyol onto the proppant.

In one embodiment the proppant simply comprises the particle such as particle of frac sand or a polymeric particle, with the surface treatment applied thereon, i.e., onto an outer surface thereof. However, in other embodiments the proppant comprises a polymer or includes a polymeric coating disposed on a particle. In such embodiments, the step of applying the surface treatment to the particle can be conducted simultaneous with the formation of the polymeric coating and/or simultaneous with the formation of the polymeric coating. For example, if the proppant comprises a particle having a polycarbodiimide coating formed thereon the surface treatment can be included in the reaction mixture of isocyanate and catalyst which is heated to an elevated temperature to form the polycarbodiimide coating. Of course, in such an example, the surface treatment can be applied to the proppant once the particle is coated with the polycarbodiimide coating. Advantageously, the surface treatment can be applied to the proppant immediately following the coating of the particle with the polycarbodiimide coating even though the proppant may have a temperature greater than 100, alternatively greater than 150° C., alternatively greater than 170° C., alternatively greater than 190, alternatively greater than 210, alternatively greater than 230, alternatively greater than 250, ° C. Said differently, the method may further comprise the step of heating the proppant to a temperature greater than 100, alternatively greater than 150, alternatively greater than 170, alternatively greater than 190, alternatively greater than 210, alternatively greater than 230, alternatively greater than 250, ° C. prior to, simultaneous with, and/or subsequent to the step of applying the surface treatment.

The method optionally includes the step of dispersing the surface treatment in an application fluid, e.g. an organic solvent, acetone, etc., prior to the step of applying the surface treatment. The step of dispersing the surface treatment in an application fluid facilitates the application of the surface treatment onto the outer surface of the proppant, to help ensure that the surface treatment is homogenously dispersed on the exterior surface of the proppant.

Various techniques can be used to coat the particle with the surface treatment. These techniques include, but are not limited to, mixing, pan coating, fluidized-bed coating, co-extrusion, spraying, in-situ formation of the surface treatment, and spinning disk encapsulation. The technique for applying the surface treatment to the particle is selected according to cost, production efficiencies, and batch size.

In one embodiment, the surface treatment is disposed on the particle via mixing in a vessel, e.g. a reactor. In particular, the components of the proppant, e.g. the particle (coated or uncoated), the quaternary ammonium compound, and the polyether polyol are added to the vessel to form a mixture. The reaction mixture is typically agitated at an agitator speed commensurate with the viscosities of the components. It is to be appreciated that the technique of mixing may include adding components to the vessel sequentially or concurrently. Also, the components may be added to the vessel at various time intervals and/or temperatures.

In another embodiment, the surface treatment is disposed on the particle via spraying. In particular, individual components of the surface treatment are contacted in a spray device to form a coating mixture. The coating mixture is then sprayed onto the particle to form the proppant. Spraying the surface treatment onto the particle typically results in a uniform, complete coating of the proppant with the surface treatment. That is, the surface treatment is typically even, unbroken, and has adequate thickness and acceptable integrity when spray applied. Spraying also typically results in a thinner and more uniform amount of surface treatment disposed on the particle as compared to other techniques, and thus the proppant is coated economically. Spraying the particle even permits a continuous manufacturing process. Spray temperature is typically selected according to surface treatment technology and ambient humidity conditions. Further, the components of the surface treatment are sprayed at a viscosity commensurate with the viscosity of the components.

The formed proppant is typically prepared according to the method as set forth above and stored in an offsite location before being pumped into the subterranean formation and the subsurface reservoir. As such, coating typically occurs offsite from the subterranean formation and subsurface reservoir. However, it is to be appreciated that the proppant may also be prepared just prior to being pumped into the subterranean formation and the subsurface reservoir. In this scenario, the proppant may be prepared with a portable coating apparatus at an onsite location of the subterranean formation and subsurface reservoir.

The proppant is useful for hydraulic fracturing of the subterranean formation to enhance recovery of petroleum and the like. In a typical hydraulic fracturing operation, a hydraulic fracturing composition, i.e., a mixture, comprising the carrier fluid, the proppant, and optionally various other components, is prepared. The carrier fluid is selected according to wellbore conditions and is mixed with the proppant to form the mixture which is the hydraulic fracturing composition. The carrier fluid can be a wide variety of fluids including, but not limited to, kerosene and water. Typically, the carrier fluid is water. Various other components which can be added to the mixture include, but are not limited to, guar, polysaccharides, and other components know to those skilled in the art.

The mixture is pumped into the subsurface reservoir, which may be the wellbore, to cause the subterranean formation to fracture. More specifically, hydraulic pressure is applied to introduce the hydraulic fracturing composition under pressure into the subsurface reservoir to create or enlarge fractures in the subterranean formation. When the hydraulic pressure is released, the proppant holds the fractures open, thereby enhancing the ability of the fractures to extract petroleum fuels or other subsurface fluids from the subsurface reservoir to the wellbore.

For the method of filtering a fluid, the proppant of the subject disclosure is provided according to the method of forming the proppant as set forth above. In one embodiment, the subsurface fluid can be unrefined petroleum or the like. However, it is to be appreciated that the method of the subject disclosure may include the filtering of other subsurface fluids not specifically recited herein, for example, air, water, or natural gas.

To filter the subsurface fluid, the fracture in the subsurface reservoir that contains the unrefined petroleum, e.g. unfiltered crude oil, is identified by methods known in the art of oil extraction. Unrefined petroleum is typically procured via a subsurface reservoir, such as a wellbore, and provided as feedstock to refineries for production of refined products such as petroleum gas, naphtha, gasoline, kerosene, gas oil, lubricating oil, heavy gas, and coke. However, crude oil that resides in subsurface reservoirs may include impurities such as sulfur, undesirable metal ions, tar, and high molecular weight hydrocarbons. Such impurities foul refinery equipment and lengthen refinery production cycles, and it is desirable to minimize such impurities to prevent breakdown of refinery equipment, minimize downtime of refinery equipment for maintenance and cleaning, and maximize efficiency of refinery processes.

For the method of filtering, the hydraulic fracturing composition is pumped into the subsurface reservoir so that the hydraulic fracturing composition contacts the unfiltered crude oil. The hydraulic fracturing composition is typically pumped into the subsurface reservoir at a rate and pressure such that one or more fractures are formed in the subterranean formation. The pressure inside the fracture in the subterranean formation may be greater than 5,000, greater than 7,000, or even greater than 10,000 psi, and the temperature inside the fracture is typically greater than 70° F. and can be as high 375° F. depending on the particular subterranean formation and/or subsurface reservoir.

Although not required for filtering, the proppant can be a controlled-release proppant. A controlled-release proppant typically includes the particle, the polymeric coating, and the surface treatment. The surface treatment does not interfere with the controlled-released polymeric coating. With a controlled-release proppant, while the hydraulic fracturing composition is inside the fracture, the polymeric coating of the proppant typically dissolves in a controlled manner due to pressure, temperature, pH change, and/or dissolution in the carrier fluid in a controlled manner or the polymeric coating is disposed about the particle such that the particle is partially exposed to achieve a controlled-release. Complete dissolution of the polymeric depends on the thickness of the polymeric coating and the temperature and pressure inside the fracture, but typically occurs within 1 to 4 hours. It is to be understood that the terminology “complete dissolution” generally means that less than 1% of the coating remains disposed on or about the particle. The controlled-release allows a delayed exposure of the particle to crude oil in the fracture. In the embodiment where the particle includes the active agent, such as the microorganism or catalyst, the particle typically has reactive sites that must contact the fluid, e.g. the crude oil, in a controlled manner to filter or otherwise clean the fluid. If implemented, the controlled-release provides a gradual exposure of the reactive sites to the crude oil to protect the active sites from saturation. Similarly, the active agent is typically sensitive to immediate contact with free oxygen. The controlled-release provides the gradual exposure of the active agent to the crude oil to protect the active agent from saturation by free oxygen, especially when the active agent is a microorganism or catalyst.

To filter the fluid, the particle, which is substantially free of the polymeric coating after the controlled-release, contacts the subsurface fluid, e.g. the crude oil. It is to be understood that the terminology “substantially free” means that complete dissolution of the polymeric coating has occurred and, as defined above, less than 1% of the surface treatment remains disposed on or about the particle. This terminology is commonly used interchangeably with the terminology “complete dissolution” as described above. In an embodiment where an active agent is utilized, upon contact with the fluid, the particle typically filters impurities such as sulfur, unwanted metal ions, tar, and high molecular weight hydrocarbons from the crude oil through biological digestion. As noted above, a combination of sands/sintered ceramic particles and microorganisms/catalysts are particularly useful for filtering crude oil to provide adequate support/propping and also to filter, i.e., to remove impurities. The proppant therefore typically filters crude oil by allowing the delayed exposure of the particle to the crude oil in the fracture.

The filtered crude oil is typically extracted from the subsurface reservoir via the fracture, or fractures, in the subterranean formation through methods known in the art of oil extraction. The filtered crude oil is typically provided to oil refineries as feedstock, and the particle typically remains in the fracture.

Alternatively, in a fracture that is nearing its end-of-life, e.g. a fracture that contains crude oil that cannot be economically extracted by current oil extraction methods, the particle may also be used to extract natural gas as the fluid from the fracture. The particle, particularly where an active agent is utilized, digests hydrocarbons by contacting the reactive sites of the particle and/or of the active agent with the fluid to convert the hydrocarbons in the fluid into propane or methane. The propane or methane is then typically harvested from the fracture in the subsurface reservoir through methods known in the art of natural gas extraction.

The following examples are meant to illustrate the invention and are not to be viewed in any way as limiting to the scope of the disclosure.

### EXAMPLES

As described above, the subject disclosure provides a proppant which includes a surface treatment comprising an antistatic component and a hydrophilic component. The first section below titled “The Antistatic Component” sets forth a description and examples of the antistatic component and a quaternary ammonium compound thereof. The second section below titled “The Hydrophilic Component” sets forth a description and examples of the hydrophilic component and a polyether polyol thereof. The final section below titled “Examples 1-10” describes proppants formed in accordance with the subject disclosure. More specifically, Examples 1-10 are proppants formed by applying the surface treatment comprising the antistatic component and the hydrophilic component to an outer surface of a coated particle.

### The Antistatic Component

Antistatic Components 1-5 comprise Quaternary Ammonium Compounds (Quats) 1-5. The structural characteristics of and thermal stability of Quats 1-5 are set forth in Table 1 below.

To test thermal stability, a sample of each quat is analyzed on a TA Instruments, Model Q5000 Thermogravimetric Analyzer with an IR heat source at designated temperature (170° C., 190° C., etc). After exposure to the designated temperature for four minutes, the percent weight loss of the sample is calculated. Lower percent weight loss numbers are an indication of thermally stability.

TABLE 1

| | | | | | Thermal | Thermal |
|---|---|---|---|---|---|---|
| | | | | | Stability | Stability |
| | | | | | at 170° C. | at 190° C. |
| | Quaternary | | | | (% Wt. | (% Wt. |
| | Ammonium | MW | | | Loss over | Loss over |
| Quat No. | Compound | (g/mol) | Anion | Class | 4 min) | 4 min) |
| 1 | Dicocoyl ethyl | 560 | Sulfate | Cationic | — | — |
| | hydroxyethylmonium | | | | | |
| | methosulfate | | | | | |
| 2 | Soybean oil (C16-18) | >500 | Sulfate | Cationic | 1.5 | 1.6 |
| | with an ethosulfate | | | | | |
| | quat | | | | | |
| 3 | Cocamidopropyl | 425 | Sulfate | Cationic | 14.5 | 3.7 |
| | hydroxysultaine | | | | | |
| 4 | Benzalkonium | 360 | Chloride | Cationic | 41.2 | 47.2 |
| | chloride | | | | | |
| 5 | Hexadecyltrimethyl | 320 | Chloride | Cationic | 0.2 | 0.5 |
| | ammonium chloride | | | | | |

Antistatic Components 1-5 are tested for their effectiveness as an antistat on Proppant Samples 1-12 with volume resistivity and charge decay measurements. The volume resistivity and charge decay measurements are set forth in Table 2 below.

To test volume resistivity and charge decay, Proppant Samples 1-12 are formed by applying Antistatic Components 1-5 to an outer surface of a coated particle (a particle having a polycarbodiimide coating disposed thereon). The coating is a polycarbodiimide coating which is present on an outer surface of the particle in an amount of about 3.5 parts by weight, based on 100 parts by weight of the particle. The particle is 40/70 Ottawa frac sand. Said differently, the particle is Ottawa frac sand having a diameter of from 212 to 425 μm. Antistatic Components 1-5 are applied to the outer surface of the coated particle in the amounts specified in Table 2.

Once the proppant samples are formed, volume resistivity (ohm-m) is measured using Tera-Ohm-Meter 6206 with powder measuring cell (#6221). Volume resistivity (often referred to as pD) is defined as the ratio of the dc voltage drop per unit thickness to the amount of current per unit area passing through the material. Volume resistivity indicates how readily a material conducts electricity through the bulk of the material.

Volume resistance (often referred to as R_{D}) is defined as the ratio of dc voltage to current passing between two electrodes (of a specified configuration) that contact opposite sides of the material of the object under test. Volume resistance is reported in ohms Laboratory measurements of volume resistance are made as per Deutsches Insitut fur Normung E.V. (DIN) 53 482.

The volume resistivity is determined from the volume resistance and the physical shape of the test specimen by the expression:

ρ_{D}=R_{D}A/L

### Where,

ρ_{D}: Volume resistivity (Ω-m)
R_{D}: Volume resistance (Ω)
A: Electrode area (m²)
L: Thickness of the specimen (m)

Once the proppant samples are formed, charge decay measurements are also conducted. Charge decay measurements measure the ability of the proppant sample to dissipate charges. Specifically, charge decay time (often referred to as t50) is the time it takes for the field strength to decay to 50% of its initial value.

Charge decay measurements are conducted in accordance with British Standard BS 7506. The proppant samples are corona charged for 30 seconds with a 400,000 volt Van de Graaff generator. Field strength is measured with a Chubb JCI 111 electrostatic fieldmeter.

All volume resistivity and charge decay measurements are conducted at ambient conditions (27° C. and 4% relative humidity).

Table 2 below sets forth the test results for volume resistivity and charge decay time measurements on Proppant Samples 1-12 having Antistatic Components 1-5 applied on the outer surface thereof. Generally, the lower the volume resistance and the charge decay time number of the Proppant Sample, the more effective the Antistatic Component.

TABLE 2

| | Antistatic Component | | | | | |
|---|---|---|---|---|---|---|
| | Quarter- | | | | Volume | Charge |
| Proppant | nary | | | | Resistivity | Decay |
| Sample | Compo- | | | | (ρ_{D}) | Time (t₅₀) |
| No. | nent | Solvent | Loading | | (Ω-m) | (seconds) |
| Control | (a coated particle having no antistatic | | | | 3.9 × 10¹³ | 66 |
| | component thereon) | | | | | |
| 1 | Quat 1 | Acetone | 100 | ppm | 2.2 × 10¹¹ | 7 |
| 2 | Quat 1 | Acetone | 200 | ppm | 1.9 × 10¹¹ | 7 |
| 3 | Quat 1 | Acetone | 300 | ppm | 1.2 × 10¹¹ | 6 |
| 4 | Quat 1 | Acetone | 400 | ppm | 1.7 × 10¹¹ | 7 |
| 5 | Quat 2 | — | 0.04 | PBW* | 3 × 10¹⁰ | 2 |
| 6 | Quat 2 | — | 0.03 | PBW | 2 × 10¹⁰ | 2 |
| 7 | Quat 2 | — | 0.02 | PBW | 3 × 10¹⁰ | 2 |
| 8 | Quat 2 | — | 0.01 | PBW | 9 × 10¹⁰ | 8 |
| 9 | Quat 4 | Water | 200 | ppm | 2.9 × 10¹⁰ | 4 |
| 10 | Quat 4 | Water | 400 | ppm | 3.3 × 10¹⁰ | 4 |
| 11 | Quat 3 | Water | 0.10 | PBW | 4 × 10¹¹ | 66 |
| 12 | Quat 5 | Water | 400 | ppm | 1.9 × 10¹¹ | 117 |

*PBW—parts by weight based on 100 parts by weight of the coated particle.

Referring now to Tables 1 and 2, Quats 1 and 2 are thermally stable at temperatures exceeding 170° C. and impart excellent antistatic properties on the proppant samples. Notably, Quats 1 and 2 are higher molecular weight (>500 g/mol) cationic quats having a sulfate anion. As such, cationic quats having a molecular weight of greater than 500 g/mol are particularly effective in the antistatic component.

### The Hydrophilic Component

Hydrophilic Components 1-14 comprise Polyether Polyols 1-11 and, in some cases, also comprise one or more antioxidants. The structural characteristics of and thermal stability of Polyether Polyols 1-11 are set forth in Table 3 below.

TABLE 3

| | | OH | | | | | | |
|---|---|---|---|---|---|---|---|---|
| | | No. | | | | PO | EO | |
| | Viscosity | (mg | | | Mol. | Groups | Groups | |
| Polyether | at 73° C. | KOH/ | Nom. | | Weight | (% by | (% by | End |
| Polyol | (cps) | g) | Funct. | Initiator | (g/mol) | weight) | weight) | Caps |
| 1 | 570 | 56 | 3.00 | Glycerine | 3000 | 91.67% | 8.33% | PO |
| | | | | (Gly.) | | | | |
| 2 | 1340 | 46 | 2.96 | Gly. | 3606 | 24.74% | 75.26% | EO PO |
| | | | | | | | | Heteric |
| 3 | wax-like | 50 | 1.00 | Methanol | 1000 | 0.00% | 100.00% | EO |
| 4 | wax-like | 19 | 1.00 | Methanol | 3000 | 0.00% | 100.00% | EO |
| 5 | 1268 | 328 | 4.00 | Alkanol | 683 | 100.00% | 0.00% | PO |
| | | | | amide | | | | |
| 6 | 150 | 110 | 1.00 | C12C14 | 508 | 0.00% | 100.00% | EO |
| | | | | FAE | | | | |
| 7 | 291 | 500 | 2.98 | MEOA | 334 | 61.54% | 38.46% | EO |
| 8 | 3440 | 920 | 3.00 | TMP | 183 | 0.00% | 100.00% | EO |
| 9 | 830 | 35 | 2.63 | Gly. | 4214 | 81.63% | 18.37% | EO |
| 10 | 1202 | 31 | 2.77 | Gly./ | 4693 | 81.38% | 18.62% | EO |
| | | | | Sorbitol | | | | |
| 11 | 100,000 | 767 | 4.00 | EDA | 293 | 100.00% | 0.00% | PO |

Hydrophilic Components 1-14 are tested for hydrophilicity and thermal stability. The test results are set forth in Table 4 below.

To test hydrophilicity, Proppant Samples 1-14 are formed by applying Hydrophilic Components 1-14 to an outer surface of a coated particle—a particle having a polycarbodiimide coating disposed thereon. The coating is a polycarbodiimide coating which is present on an outer surface of the particle in an amount of about 3.5 parts by weight, based on 100 parts by weight of the particle. The particle is 40/70 Ottawa frac sand. Said differently, the particle is Ottawa frac sand having a diameter of from 212 to 425 μm. Hydrophilic Components 1-14 are each applied to the outer surface of the coated particle in an amount of 0.1 percent by weight based on the total weight of the proppant.

To test hydrophilicity, 50 g of proppant sample (having the hydrophilic component thereon) is added to a 500 mL of water in a beaker. Objective observations are made regarding the hydrophilic/hydrophobic character of each proppant sample. More specifically, observations are made as to whether air is retained on the surfaces of, and entrapped by, the proppant sample added to the water and observations are also made regarding the tendency of the proppant sample to agglomerate while in the water. The proppant sample is then assigned a numerical rating between 1 and 5. If the proppant sample agglomerates and retains air, it is given a rating of 5 (characterized as hydrophobic). If the proppant sample disperses evenly on the bottom of the beaker and does not retain air, it is given a rating of 1 (characterized as hydrophilic). As such, the lower the rating, the more hydrophilic the proppant sample and the hydrophilic component thereof. A particle comprising uncoated sand would be considered a value of 1 as a benchmark.

To test thermal stability, a sample of each hydrophilic component is analyzed on a TA Instruments, Model Q5000 Thermogravimetric Analyzer with an IR heat source at designated temperature (170° C., 190° C., etc). After exposure to the designated temperature for four minutes, the percent weight loss of the sample is calculated. Lower percent weight loss numbers are an indication of thermally stability.

TABLE 4

| | | | | Thermal | Thermal |
|---|---|---|---|---|---|
| | | | | Stability | Stability |
| | | | | at | at |
| | | | | 170° C. | 190° C. |
| | | | | (% Wt. | (% Wt. |
| Proppant | Hydrophilic Component | | Hydrophilic | Loss | Loss |
| Sample | Polyether | Antioxidant | Character | over | over |
| No. | Polyol | (PBW*) | (Rating 1-5) | 4 min.) | 4 min.) |
| Control | | | 5 | — | — |
| (No Hydrophilic Component) | | | | | |
| 1 | 1 | 0.375 AO A | 2 | 0.1 | 0.2 |
| | | 0.225 AO B | | | |
| 2 | 2 | 0.3 AO A | 2 | 0.2 | 0.3 |
| | | 0.15 AO B | | | |
| 3 | 3 | — | 2 | 0.5 | 1.4 |
| 4 | 4 | — | 2 | 1.4 | 1.8 |
| 5 | 5 | — | 3 | 3.3 | 3.3 |
| 6 | 6 | — | 1 | 3.5 | 8.3 |
| 7 | 7 | — | 1 | 4.3 | 9.4 |
| 8 | 7 | 0.375 AO A | 1 | 4.2 | 9.0 |
| | | 0.225 AO B | | | |
| 9 | 8 | 0.1 AO C | 1 | 9.4 | 19.8 |
| 10 | 9 | 0.15 AO A | 5 | 1.9 | 6.0 |
| 11 | 10 | — | 5 | 2.2 | 6.5 |
| 12 | 10 | 0.375 AO A | 5 | 0.1 | 0.3 |
| | | 0.225 AO B | | | |
| 13 | 11 | — | 5 | 3.0 | 7.9 |
| 14 | 11 | 0.375 AO A | 5 | 2.3 | 4.1 |
| | | 0.225 AO B | | | |

*PBW—parts by weight based on 100 parts by weight of the polyether polyol.

Antioxidant A (AO A) is a liquid hindered phenolic antioxidant comprising benzenepropanoic acid and 3,5-bis (1,1-dimethyl-ethyl)-4-hydroxy-C7-C9 branched alkyl esters.

Antioxidant B (AO B) is a liquid aromatic amine antioxidant comprising benzenamine, N-phenyl-,reaction products with 2,4,4-trimethylpentene.

Referring now to Tables 3 and 4, Polyether Polyol 1 is thermally stable at temperatures exceeding 170° C. and imparts hydrophilic character to the proppant formed with Hydrophilic Component 1. Notably, Polyether Polyol 1 is glycerine initiated, has a molecular weight of 3000 g/mol, has a nominal functionality of 3, and is 100% PO end capped. Likewise, Polyether Polyol 2 is thermally stable at temperatures exceeding 170° C. and imparts hydrophilic character to the proppant formed with Hydrophilic Component 2. Polyether Polyol 2 is also glycerine initiated, has a molecular weight of 3606 g/mol, has a nominal functionality of 3, and has PO end capping. As such, glycerine initiated polyether polyols having a molecular weight of greater than 3000 g/mol, a nominal functionality of about 3, and PO end capping are particularly effective in the hydrophilic component.

Polyether Polyols 3, 4, and 6 are thermally stable at temperatures exceeding 170° C. and impart hydrophilic character to the proppant. Notably, these polyether polyols have a molecular weight of from 500 to 3000 g/mol, a nominal functionality of 1, and are 100% EO end capped. As such, polyols having a molecular weight of between 500 and 3000 g/mol, a nominal functionality of about 1, and EO end capping are also particularly effective in the hydrophilic component.

### Examples 1-10

Examples 1-10 are proppants formed according to the subject disclosure comprising the surface treatment disposed an outer surface of a coated particle. The coating is a polycarbodiimide coating which is present on an outer surface of the particle in an amount of about 3.5 parts by weight, based on 100 parts by weight of the particle. The particle is 40/70 Ottawa frac sand. That is, the particle is Ottawa frac sand having a diameter of from 212 to 425 μm. Surface Treatments 1-10 are each applied to the outer surface (comprising polycarbodiimide) of the coated particle in an amount of 0.2 percent by weight based on the total weight of the proppant. Acetone is used as an application fluid to ensure homogeneous coating of the coated particle with the surface treatment.

To form Examples 1-10, pursuant to the formation of the coated particle in a mixer, the Surface Treatment is added to the mixer. The mixer and coated particle therein is at a temperature of 170° C. when the Surface treatment is added. The coated particle and the surface treatment are mixed for about 4 minutes. More specifically, the particle is mixed for about 3 minutes and then the surface treatment is applied. Once the surface treatment is applied, the particle and the surface treatment are mixed for about 1 additional minute to form the proppant of Examples 1-10.

The components and amount of the components used to form Examples 1-10 are disclosed in Table 5 below.

TABLE 5

| | | | | | | | | | | | Ex. |
|---|---|---|---|---|---|---|---|---|---|---|---|
| Component | | Ex. 1 | Ex. 2 | Ex. 3 | Ex. 4 | Ex. 5 | Ex. 6 | Ex. 7 | Ex. 8 | Ex. 9 | 10 |
| Particle | | 100 | 100 | 100 | 100 | 100 | 100 | 100 | 100 | 100 | 100 |
| Polycarbodiimide | | 3.5 | 3.5 | 3.5 | 3.5 | 3.5 | 3.5 | 3.5 | 3.5 | 3.5 | 3.5 |
| Coating | | | | | | | | | | | |
| Surface | Quat 1 | 0.1 | 0.1 | 0.1 | 0.1 | 0.1 | — | — | — | — | — |
| Treatment | Quat 2 | — | — | — | — | — | 0.1 | 0.1 | 0.1 | 0.1 | 0.1 |
| | Polyether | 0.1 | — | — | — | — | 0.1 | — | — | — | — |
| | Polyol 1 | | | | | | | | | | |
| | Polyether | — | 0.1 | — | — | — | — | 0.1 | — | — | — |
| | Polyol 2 | | | | | | | | | | |
| | Polyether | — | — | 0.1 | — | — | — | — | 0.1 | — | — |
| | Polyol 3 | | | | | | | | | | |
| | Polyether | — | — | — | 0.1 | — | — | — | — | 0.1 | — |
| | Polyol 4 | | | | | | | | | | |
| | Polyether | — | — | — | — | 0.1 | — | — | — | — | 0.1 |
| | Polyol 5 | | | | | | | | | | |

Surface Coatings 1-10 are thermally stable at temperatures exceeding 170° C. and impart hydrophilic character and antistatic properties to the proppants of Examples 1-10.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present disclosure has been described in an illustrative manner, and it is to be understood that the terminology which has been used is intended to be in the nature of words of description rather than of limitation. Obviously, many modifications and variations of the present disclosure are possible in light of the above teachings. It is, therefore, to be understood that within the scope of the appended claims, the present disclosure may be practiced otherwise than as specifically described.

1. A proppant for hydraulically fracturing a subterranean formation, said proppant including a surface treatment which comprises:
A. an antistatic component comprising a quaternary ammonium compound; and
B. a hydrophilic component comprising a polyether polyol.

2. A proppant as set forth in claim 1 comprising a particle selected from the group of minerals, ceramics, sands, nut shells, gravels, mine tailings, coal ashes, rocks, smelter slag, diatomaceous earth, crushed charcoals, micas, sawdust, wood chips, resinous particles, polymeric particles, and combinations thereof.

3. A proppant as set forth in claim 2 further comprising a polymeric coating disposed on said particle comprising a polymer selected from the group of polyurethane, polycarbodiimide, polyamide, polyimide, polyurea, polyacrylate, epoxy, polystyrene, polysulfide, polyoxazolidone, polyisocyanaurate, polysilicate (sodium silicate), polyvinylchloride, phenol formaldehyde resins (novolacs and resoles), and combinations thereof, wherein said surface treatment is disposed on an exterior surface of said polymeric coating.

4. A proppant as set forth in claim 3 wherein said polymeric coating comprises polycarbodiimide.

5. A proppant as set forth in claim 1 wherein said quaternary ammonium compound comprises a chloride anion.

6. A proppant as set forth in claim 1 wherein said quaternary ammonium compound comprises a sulfate anion.

7. A proppant as set forth in claim 1 wherein said quaternary ammonium compound has a weight loss of less than 5 percent by weight after exposure to a temperature of 170° C. for four minutes.

8. A proppant as set forth in claim 1 wherein said quaternary ammonium compound has a weight-average molecular weight of from 150 to 5,000 g/mol.

9. A proppant as set forth in claim 1 wherein said polyether polyol has a weight average molecular weight of from 250 to 10,000 g/mol.

10. A proppant as set forth in claim 1 wherein said polyether polyol has a nominal functionality of from 1 to 8.

11. A proppant as set forth in claim 1 wherein said polyether polyol comprises ethyleneoxy groups and propyleneoxy groups in a molar ratio of from 4:1 to 1:15.

12. A proppant as set forth in claim 1 wherein said polyether polyol comprises about 100% propyleneoxy end caps.

13. A proppant as set forth in claim 1 wherein said polyether polyol has a weight loss of less than 5 percent by weight after exposure to a temperature equal to or greater than 170° C. for four minutes.

14. A proppant as set forth in claim 1 wherein said surface treatment further comprises an antioxidant.

15. A proppant as set forth in claim 1 wherein said surface treatment includes said quaternary ammonium compound and said polyether polyol in a weight ratio of 4:1 to 1:4.

16. A proppant as set forth in claim 1 comprising from 0.01 to 1 percent by weight said surface treatment, based on the total weight of the proppant.

17. A method of forming the proppant as set forth in claim 1 for hydraulically fracturing a subterranean formation, said method comprising the step of applying the surface treatment onto the proppant.

18. A method as set forth in claim 17 further comprising the step of heating the proppant to a temperature greater than 150° C. prior to, simultaneous with, and/or subsequent to the step of applying the surface treatment.

19. A method of hydraulically fracturing a subterranean formation which defines a subsurface reservoir with a mixture comprising a carrier fluid and the proppant as set forth in claim 1, said method comprising the step of pumping the mixture into the subsurface reservoir to cause the subterranean formation to fracture.

20. A proppant as set forth in claim 3 wherein said polymeric coating comprises polycarbodiimide, and wherein said quaternary ammonium compound comprises an anion selected from a chloride anion and a sulfate anion.
